(19) United States
(12) Patent Application Publication
(10) Pub. No.: US 2024/0221583 A1
(43) Pub. Date: Jul. 4, 2024

(54) METHOD FOR ACQUIRING ANALOG SYPPLY VOLTAGE, AND DISPLAY APPARATUS

(71) Applicant: Wuhan Tianma Microelectronics Co., Ltd., Wuhan (CN)

(72) Inventors: Xigang LIU, Wuhan (CN); Chuan LIU, Wuhan (CN); Zhihua YU, Wuhan (CN)

(73) Assignee: Wuhan Tianma Microelectronics Co., Ltd., Wuhan (CN)

(21) Appl. No.: 18/603,425

(22) Filed: Mar. 13, 2024

(30) Foreign Application Priority Data
Apr. 11, 2023 (CN) 202310400112.5

(51) Int. Cl. G09G 3/20

(52) U.S. Cl. CPC G09G 3/2074; G09G 2310/027; G09G 2320/0276; G09G 2330/028

(57) ABSTRACT

Provided are a method and module for acquiring an analog supply voltage, and a display apparatus. In an embodiment, the analog supply voltage is provided to the display driver chip that drives a display panel. In an embodiment, the method includes providing a minimum-grayscale test voltage by the display driver chip to the display panel, and acquiring actual brightness of the display panel at the minimum-grayscale test voltage; adjusting the minimum-grayscale test voltage according to the actual brightness of the display panel, and using the minimum-grayscale test voltage at which the actual brightness of the display panel reaches target dark state brightness as a first main gamma voltage; and obtaining an analog supply voltage according to the first main gamma voltage.

### CROSS-REFERENCE TO RELATED APPLICATION

The present application claims priority to Chinese Patent Application No. 202310400112.5, filed on Apr. 11, 2023, the content of which is incorporated herein by reference in its entirety.

### TECHNICAL FIELD

The present disclosure relates to the field of display technology, and in particular, to a method for acquiring an analog supply voltage, and a display apparatus.

### BACKGROUND

As an important part of the information industry, display technology has always played a very important role during development of the information technology. Display technology has been extensively applied in industry, transportation, communication, education, aerospace, satellite remote sensing, entertainment, medical care, and other aspects of daily life, and is an important pillar of the information industry.

A display panel and a display driver chip are key components of the display technology. The display panel operates under the drive of the display driver chip. The display driver chip needs to receive an analog supply voltage AVDD. The magnitude of the analog supply voltage AVDD not only affects normal operation of the display driver chip, but also directly affects power consumption of the display driver chip.

Display panels that are different in structures, materials, or manufacturing processes require analog supply voltages AVDD of different magnitudes. How to provide the display driver chip with an analog supply voltage AVDD that enables the display panel to be driven normally and causes low power consumption has become the attention focus of researchers.

### SUMMARY

In view of this, embodiments of the present disclosure provide a method and module for acquiring an analog supply voltage, and a display apparatus.

According to an aspect, an embodiment of the present disclosure provides a method for acquiring an analog supply voltage. In an embodiment, the analog supply voltage is provided to a display driver chip. In an embodiment, the display driver chip is used to drive a display panel. In an embodiment, the method includes: providing a minimum-grayscale test voltage to the display driver chip, and acquiring actual brightness of the display panel at the minimum-grayscale test voltage; adjusting the minimum-grayscale test voltage according to the actual brightness of the display panel, and using the minimum-grayscale test voltage at which the actual brightness of the display panel reaches target dark state brightness as a first main gamma voltage; and obtaining the analog supply voltage according to the first main gamma voltage.

According to another aspect, an embodiment of the present disclosure provides a module for acquiring an analog supply voltage. In an embodiment, the analog supply voltage is provided to a display driver chip, and the display driver chip is used to drive a display panel. In an embodiment, the module includes: a minimum-grayscale test voltage supply unit configured to provide a minimum-grayscale test voltage to the display panel; a brightness acquisition unit configured to acquire actual brightness of the display panel at the minimum-grayscale test voltage; a first main gamma voltage acquisition unit configured to use the minimum-grayscale test voltage at which the actual brightness of the display panel reaches target dark state brightness as a first main gamma voltage; and an analog supply voltage acquisition unit configured to obtain the analog supply voltage according to the first main gamma voltage.

According to still another aspect, an embodiment of the present disclosure provides a display apparatus. In an embodiment, the display apparatus includes a display panel and a display driver chip. The display driver chip is configured to receive an analog supply voltage, the magnitude of the analog supply voltage is determined according to the method described above, and the display driver chip is electrically connected to the display panel.

According to still another aspect, an embodiment of the present disclosure provides a display apparatus. In an embodiment, the display apparatus includes a display panel, a display driver chip, and a power management chip. In an embodiment, the display driver chip comprises a nonvolatile memory, a first main gamma voltage generation circuit, and a second gamma voltage generation circuit. In an embodiment, the display driver chip sends a signal to the power management chip according to a parameter in the nonvolatile memory, the power management chip generates an analog supply voltage and supplies the analog supply voltage to the display driver chip, and a magnitude of the analog supply voltage is determined by the signal. The first main gamma voltage generation circuit generates, based on the analog supply voltage, a gamma voltage corresponding to a grayscale 0.

### BRIEF DESCRIPTION OF DRAWINGS

To describe the technical solutions in the embodiments of the present disclosure more clearly, the following briefly describes the accompanying drawings required to be used in the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic diagram of a display apparatus according to an embodiment of the present disclosure;

FIG. 2 is a schematic flowchart of a method for acquiring an analog supply voltage according to an embodiment of the present disclosure;

FIG. 3 is a schematic diagram of some circuits in a display driver chip according to an embodiment of the present disclosure;

FIG. 4 is a schematic flowchart of another method for acquiring an analog supply voltage according to an embodiment of the present disclosure;

FIG. 5 is a schematic diagram of a module for acquiring an analog supply voltage according to an embodiment of the present disclosure;

FIG. 6 is a schematic diagram of a minimum-grayscale test voltage supply unit according to an embodiment of the present disclosure;

FIG. 7 is a schematic diagram of a gamma data acquisition unit according to an embodiment of the present disclosure; and

FIG. 8 is a schematic block diagram of a display driver chip according to an embodiment of the present disclosure.

### DESCRIPTION OF EMBODIMENTS

For the sake of a better understanding of the technical solutions of the present disclosure, the embodiments of the present disclosure are described in detail below with reference to the accompanying drawings.

It should be noted that the embodiments in the following descriptions are only a part rather than all of the embodiments in the present disclosure. All other embodiments obtained by a person of ordinary skill in the art on the basis of the embodiments of the present disclosure without creative efforts shall fall within the protection scope of the present disclosure.

Terms used in the embodiments of the present disclosure are only for the purpose of describing specific embodiments, and are not intended to limit the present disclosure. Unless otherwise specified in the context, words, such as “a”, “the”, and “this”, in a singular form in the embodiments of the present invention and the appended claims include plural forms.

It should be understood that the term “and/or” in this specification merely describes associations between associated objects, and it indicates three types of relationships. For example, A and/or B may indicate that A exists alone, A and B coexist, or B exists alone. In addition, the character “/” in this specification generally indicates that the associated objects are in an “or” relationship.

It should be understood that although the terms “first”, “second”, and so on may be used to describe main gamma voltages in the embodiments of the present disclosure, the main gamma voltages should not be limited to these terms. These terms are used only to distinguish different main gamma voltages from each other. For example, without departing from the scope of the embodiments of the present disclosure, a first main gamma voltage may also be referred to as a second main gamma voltage, and similarly, a second main gamma voltage may also be referred to as a first main gamma voltage.

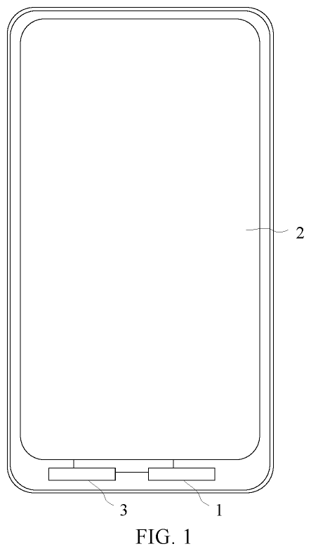

FIG. 1 is a schematic diagram of a display apparatus according to an embodiment of the present disclosure. As shown in FIG. 1, the display apparatus includes a display driver chip 1, a display panel 2, and a power management chip 3. The display driver chip 1 may be a display driver integrated circuit (DDIC) or a touch and display driver integration (TDDI). For example, the power management chip 3 is electrically connected to the display driver chip 1 and the display panel 2, and the display driver chip 1 is electrically connected to the display panel 2. During the operation of the display apparatus, the display driver chip 1 generates a first main gamma voltage VGMP based on an analog supply voltage AVDD provided by the power management chip 3, and supplies, according to received image data, a gamma data voltage corresponding to the received image data to the display panel 2 so as to drive the display panel to display. The magnitude of the gamma data voltage is between the magnitude of the first main gamma voltage VGMP and the magnitude of a second main gamma voltage VGSP. The first main gamma voltage VGMP corresponds to the minimum-grayscale brightness, that is, dark state brightness, of the display panel 2. The second main gamma voltage VGSP corresponds to the maximum-grayscale brightness of the display panel 2. For example, the first main gamma voltage VGMP is greater than the second main gamma voltage VGSP. In an example, the image data received by the display panel 2 includes 8-bit digital signals, and each data channel of the display driver chip 1 can provide 2⁸=256 gamma data voltages. In this case, the minimum grayscale is grayscale 0, and the maximum grayscale is grayscale 255.

The inventors found that due to fluctuations in structures, materials, or manufacturing processes, different display panels 2 need different first main gamma voltages VGMP. Conventionally, the analog supply voltage AVDD is set for a large number of display panels 2 before delivery. A small quantity of, such as 20, display panels 2 are selected from the large number of display panels 2 as samples. The first main gamma voltages VGMP of the sample display panels 2 are determined. A largest one of the first main gamma voltages VGMP of these sample display panels 2 is taken as the first main gamma voltage VGMP for all the display panels 2. Therefore, for a display panel that actually requires a first main gamma voltage VGMP smaller than the largest value described above, the analog supply voltage AVDD determined according to the above method is too large, resulting in large power consumption of the display driver chip 1. For a display panel that actually requires a first main gamma voltage VGMP larger than the largest value described above, the analog supply voltage AVDD determined according to the above method is too small. Consequently, the first main gamma voltage VGMP obtained accordingly is also too small, and the display panel fails to reach target dark state.

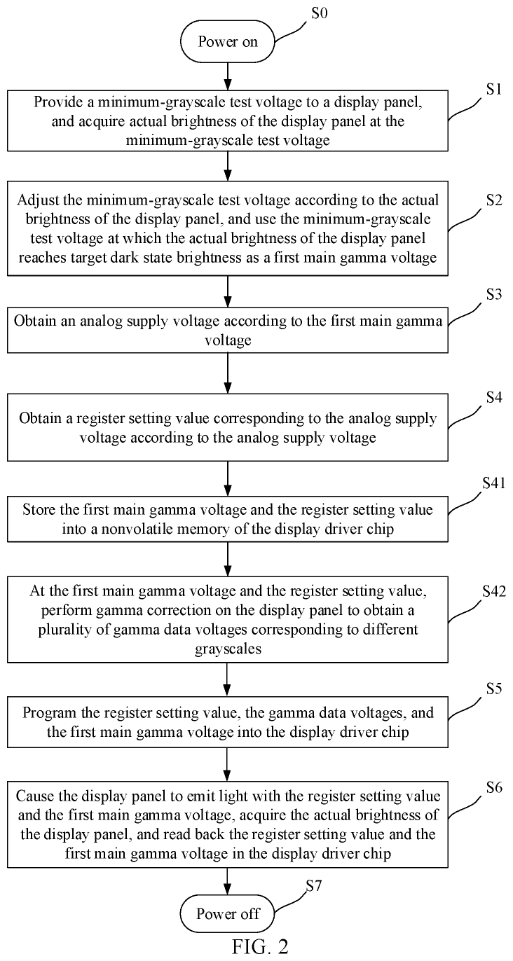

In view of this, embodiments of the present disclosure provide a method for determining a magnitude of the analog supply voltage. The analog supply voltage is provided to the display driver chip 1 shown in FIG. 1. The display driver chip 1 drives the display panel 2. FIG. 2 is a schematic flowchart of a method for determining an analog supply voltage according to embodiments of the present disclosure. As shown in FIG. 2, the method includes the following steps.

At step S1, a minimum-grayscale test voltage VGMP₀ is generated by the display driver chip 1 and supplied to the display panel 2, and actual brightness of the display panel 2 driven by the minimum-grayscale test voltage VGMP₀ is acquired. The minimum-grayscale test voltage VGMP₀ may be supplied to data lines of the display panel 2. For example, the actual brightness of the display panel 2 may be acquired in real time by using an optical measuring instrument. For example, the optical measuring instrument includes a charge-coupled device (CCD) image sensor.

At step S2, the minimum-grayscale test voltage VGMP₀ provided by the display driver chip 1 is adjusted according to the actual brightness of the display panel 2, and the minimum-grayscale test voltage at which the actual brightness of the display panel 2 reaches target dark state brightness is taken as a first main gamma voltage VGMP. For example, when the actual brightness of the display panel 2 is less than or equal to the target dark state brightness, it is determined that the actual brightness of the display panel 2 reaches the target dark state brightness. In some embodiments, the target dark state brightness may be adjusted according to different application scenarios of the display panel 2 or different accuracy requirements. For example, in this embodiment of the present disclosure, the target dark state brightness may be 0.001 nit.

At step S3, the analog supply voltage AVDD is obtained according to the first main gamma voltage VGMP. For example, the power management chip 3 is configured to output an analog supply voltage AVDD with a magnitude equal to the magnitude of the obtained first main gamma voltage VGMP.

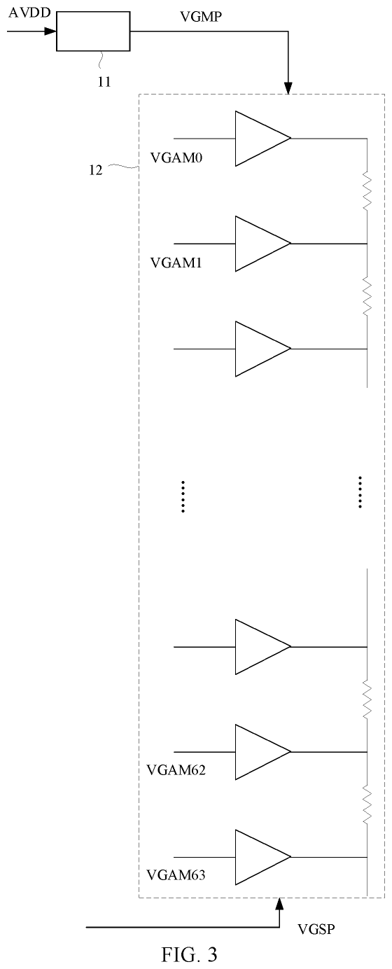

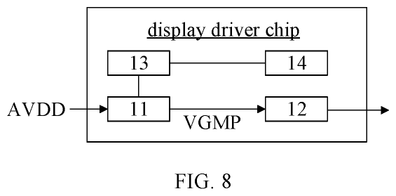

FIG. 3 is a schematic diagram of some circuits in a display driver chip according to an embodiment of the present disclosure. FIG. 8 is a schematic block diagram of a display driver chip according to an embodiment of the present disclosure. In some embodiments, as shown in FIG. 3 and FIG. 8, the display driver chip 1 includes: a resister 13, a first main gamma voltage generation circuit 11 and a second gamma voltage generation circuit 12. The first main gamma voltage generation circuit 11 receives an analog supply voltage AVDD and generates a first main gamma voltage VGMP based on the analog supply voltage AVDD. The analog supply voltage AVDD may be provided by the power management chip 3. The magnitude of the first main gamma voltage VGMP may be determined by a resister value reading by the first main gamma voltage generation circuit 11 form the resister 13. In this embodiment of the present disclosure, a correspondence between the first main gamma voltage VGMP and the analog supply voltage AVDD may be obtained according to a structure of the first main gamma voltage generation circuit 11. After a first main gamma voltage VGMP meeting a requirement of target dark state brightness is obtained, an accurate analog supply voltage AVDD can be obtained according to the foregoing correspondence.

In some embodiments, the first main gamma voltage generation circuit 11 may be a buck circuit or another circuit capable of outputting an adjustable voltage. For example, a magnitude of the first main gamma voltage VGMP is V_{GMP}, a magnitude of the analog supply voltage AVDD is V_{AVDD}, and they satisfy V_{AVDD}=V_{GMP}+C, where 0.3 V≤C≤0.5 V.

According to the method for determining the magnitude of the analog supply voltage AVDD provided in this embodiment of the present disclosure, the target first main gamma voltage VGMP is first acquired, the first main gamma voltage VGMP matches a structure, a material, or a production process feature of the display panel 2. When the display panel 2 is driven by the first main gamma voltage VGMP, the actual brightness of the display panel 2 is less than or equal to the target dark state brightness. Next, an analog supply voltage AVDD that meets a requirement of the first main gamma voltage VGMP can be obtained according to the first main gamma voltage VGMP, so that the analog supply voltage VGMP is prevented from being too large or too small. The power management chip 3 is adjusted so as to output the determined analog supply voltage AVDD. During the operation of the display apparatus, the power management chip 3 supplies such analog supply voltage AVDD to the display driver chip 1. On the one hand, the analog supply voltage AVDD is not too small, and it is avoided that the display panel 2 cannot display with the target dark state brightness, thereby improving a display effect of the display panel 2. On the other hand, the analog supply voltage AVDD is not too large, and excessive power consumption of the display driver chip 1 is avoided, thereby reducing the power consumption of the display driver chip 1.

In addition, in this embodiment of the present disclosure, the display driver chip 1 provides the minimum-grayscale test voltage VGMP₀ to the display panel 2, and the actual brightness of the display panel 2 at the minimum-grayscale test voltage is acquired. The minimum-grayscale test voltage VGMP₀ provided by the display driver chip 1 is adjusted according to the actual brightness of the display panel 2, and the minimum-grayscale test voltage at which the actual brightness of the display panel 2 is less than or equal to the target dark state brightness is used as the first main gamma voltage VGMP. Through this dynamic adjustment process, accuracy of the acquired first main gamma voltage VGMP can be improved, thereby further ensuring accuracy of the acquired analog supply voltage AVDD.

For example, in this embodiment of the present disclosure, analog supply voltages AVDD required by the display driver chips 1 bonded to different display panels 2 can be obtained according to the method described above, so that the analog supply voltage AVDD can match the structure, material, or production process feature of the display panel 2.

For example, as shown in FIG. 2, before the step S1 in which the display driver chip 1 provides the minimum-grayscale test voltage VGMP₀ to the display panel 2, the method for acquiring the analog supply voltage AVDD provided in this embodiment of the present disclosure further includes the following steps.

At step S0, a power-on operation is performed on the display driver chip 1 according to a preset power-on procedure.

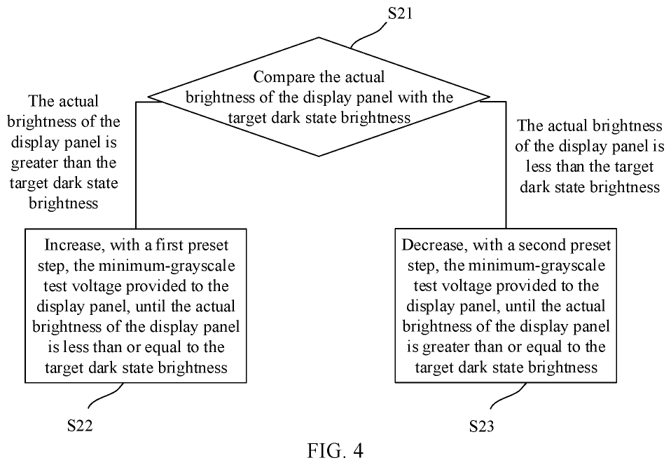

FIG. 4 is a schematic flowchart of another method for acquiring an analog supply voltage according to an embodiment of the present disclosure. For example, as shown in FIG. 4, the step S2 of adjusting the minimum-grayscale test voltage VGMP₀ according to the actual brightness of the display panel 2 includes the following steps.

At step S21, the actual brightness of the display panel 2 is compared with the target dark state brightness. Step S22 is performed when the actual brightness of the display panel 2 is greater than target dark state brightness, or step S23 is performed when the actual brightness of the display panel 2 is less than the target dark state brightness.

At step S22, the minimum-grayscale test voltage VGMP₀ provided by the display driver chip 1 is increased with a first preset step ΔV1, and actual brightness of the display panel 2 at the increased minimum-grayscale test voltage VGMP₀ is acquired. If the actual brightness of the display panel 2 is still greater than the target dark state brightness, the minimum-grayscale test voltage VGMP₀ provided by the display driver chip 1 is further increased with the first preset step ΔV1, until the actual brightness of the display panel 2 is less than or equal to the target dark state brightness. The current minimum-grayscale test voltage VGMP₀ at which the actual brightness of the display panel 2 is less than or equal to the target dark state brightness is used as the first main gamma voltage VGMP.

At step S23, the minimum-grayscale test voltage VGMP₀ provided by the display driver chip 1 is decreased with a second preset step ΔV2, and actual brightness of the display panel 2 at the decreased minimum-grayscale test voltage VGMP₀ is acquired. If the actual brightness of the display panel 2 is still less than the target dark state brightness, the minimum-grayscale test voltage VGMP₀ provided by the display driver chip 1 is further decreased with the second preset step ΔV2, until the actual brightness of the display panel 2 is greater than or equal to the target dark state brightness. The step S2 of taking the minimum-grayscale test voltage VGMP₀ at which the actual brightness of the display panel 2 reaches the target dark state brightness as the first main gamma voltage VGMP includes the following operation. A smallest one among a plurality of minimum-grayscale test voltages VGMP₀ at which the actual brightness of the display panel 2 is less than or equal to the target dark state brightness is used as the first main gamma voltage VGMP.

In some embodiments, both the first preset step ΔV1 and the second preset step ΔV2 are greater than 0. For example, in this embodiment of the present disclosure, the first preset step ΔV1 and the second preset step ΔV2 may be set to be equal. For example, both the first preset step ΔV1 and the second preset step ΔV2 are set to 0.01 V. In some other embodiments of the present disclosure, the first preset step ΔV1 and the second preset step ΔV2 are not equal.

Optionally, still with reference to FIG. 2, the method for acquiring the analog supply voltage AVDD further includes the following steps.

At step S4, a register setting value corresponding to the determined minimum-grayscale test voltages VGMP₀ is obtained according to the determined minimum-grayscale test voltage VGMP₀. For example, the display driver chip 1 includes a register 13, and the register setting value is a digital signal stored in the register. For example, the register setting value is a binary number. The minimum-grayscale test voltage VGMP provided by the display driver chip 1 is determined by the register setting value. The minimum-grayscale test voltage VGMP provided by the display driver chip 1 can be adjusted by changing the value of the binary number. When the first main gamma voltage VGMP at which the actual brightness of the display panel 2 reaches the target dark state brightness is determined, the binary number (the register setting value) is determined.

At step S5, the register setting value is programmed into a nonvolatile memory 14 of the display driver chip 1. For example, the nonvolatile memory 14 is one time programmable (OTP) memory or a multi-time programmable (MTP) memory. After the display apparatus is shipped, the register setting value is read from the nonvolatile memory 14 to the register 13, and the first main gamma voltage generation circuit 11 reads the register setting value from the register 13. The first main gamma voltage generation circuit 11 generates the first main gamma voltage VGMP corresponding to the register setting value.

With reference to FIG. 1, the display driver chip 1 is electrically connected to the power management chip 3. During the operation of the display panel 2, the display driver chip 1 may send the register setting value to the power management chip 3. The power management chip 3 may generate the corresponding analog supply voltage AVDD according to the register setting value. When the register setting value changes, a magnitude of the analog supply voltage AVDD also changes accordingly. In some embodiments, the register setting value corresponds to a quantity of power supply pulses, and the magnitude of the analog supply voltage AVDD changes with the quantity of power supply pulses. For example, when the quantity of power supply pulses is 48, the analog supply voltage AVDD may be 6.1 V. When the quantity of power supply pulses is 43, the analog supply voltage AVDD may be 7.6 V.

For example, referring to FIG. 2 again, after the register setting value is obtained at step S4, and before the register setting value is programmed into the nonvolatile memory 14 of the display driver chip 1 at step S5, the method for acquiring the analog supply voltage AVDD provided in this embodiment of the present disclosure further includes the following steps.

At step S41, the register setting value is written into the register 13 of the display driver chip 1. For example, this step may be implemented through software, for example, may be implemented by through codes and a debug tool. With the codes and the debug tool, the register setting value in the register 13 can be changed.

At step S42, at the first main gamma voltage VGMP and the register setting value, gamma correction is performed on the display panel to obtain a plurality of gamma data voltages corresponding to a plurality of grayscales. The plurality of gamma data voltages are between the first main gamma voltage VGMP and the second main gamma voltage VGSP.

When the display panel 2 displays, the display driver chip 1 can provide a gamma data voltage to a corresponding data line in the display panel 2 according to the received image data, to cause the corresponding sub-pixel to emit light with a target grayscale. This process can improve the display effect of the display panel, so that the display effect of the display panel 2 is more suitable to the characteristics of human eyes. In an example, the second gamma generation circuit 12 is of a 6-bit architecture shown in FIG. 3, that is, the display driver chip 1 supports the display of a total of 64 grayscales G0 to G63. Through this step, 64 gamma data voltages VGAM0 to VGAM63 respectively corresponding to the 64 grayscales G0 to G63 can be obtained. Alternatively, during gamma correction, in this embodiment of the present disclosure, only some gamma data voltages corresponding to some grayscales are obtained, and gamma data voltages corresponding to other grayscales are obtained through interpolation or other algorithms to improve the efficiency of gamma correction.

For example, as shown in FIG. 2, step S5 includes: the plurality of obtained gamma data voltages and the acquired analog supply voltage AVDD being programmed into the display driver chip 1 together. During the display of the display panel 2, the gamma data voltage is directly used to drive the display panel 2.

In some embodiments, step S42 of performing gamma correction on the display panel 2 to obtain the gamma data voltage includes: providing data voltages corresponding to different grayscales to the display panel 2, acquiring actual brightness of the display panel 2 at different grayscales, and when the actual brightness of the display panel 2 reaches target brightness corresponding to each grayscale, using the data voltage corresponding to each grayscale as the gamma data voltage.

It should be noted that, FIG. 3 shows only an architectural diagram of the second gamma voltage generation circuit 12. All the designs of the specific circuit should fall within the protection scope of the embodiments of the present disclosure.

For example, with reference to the FIG. 2, after the register setting value is programmed into the nonvolatile memory of the display driver chip 1 at step S5, the method for acquiring the analog supply voltage AVDD provided in this embodiment of the present disclosure further includes the following steps.

At step S6, the display panel 2 is caused to emit light with the register setting value and the first main gamma voltage VGMP, the actual brightness of the display panel 2 is acquired, and the register setting value and the first main gamma voltage VGMP in the display driver chip 1 are read back.

Step S7 is performed when the actual brightness of the display panel 2 is less than the target dark state brightness and when the register setting value and the first main gamma voltage VGMP are correct.

At step S7, a power-off operation is performed on the display driver chip 1 according to a preset power-off procedure.

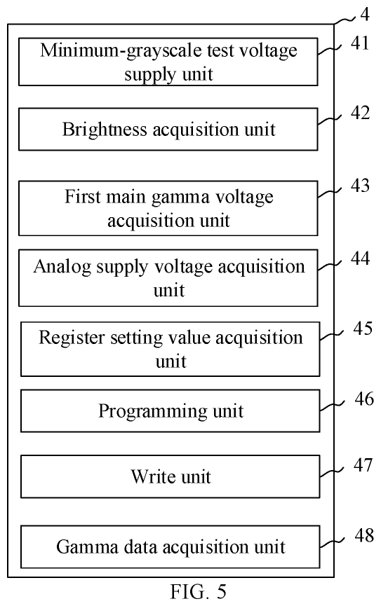

An embodiment of the present disclosure further provides a module for acquiring an analog supply voltage AVDD. FIG. 5 is a schematic diagram of a module for acquiring an analog supply voltage according to an embodiment of the present disclosure. As shown in FIG. 5, a module 4 includes a minimum-grayscale test voltage supply unit 41, a brightness acquisition unit 42, a first main gamma voltage acquisition unit 43, and an analog supply voltage acquisition unit 44. The minimum-grayscale test voltage supply unit 41 is electrically connected to the display panel 2 (not shown in FIG. 5) and configured to provide a minimum-grayscale test voltage VGMP₀ to the display panel 2. The brightness acquisition unit 42 is configured to acquire actual brightness of a display panel 2 at the minimum-grayscale test voltage VGMP₀. For example, the brightness acquisition unit 42 includes an optical measuring instrument. Optionally, the optical measuring instrument includes a CCD image sensor. The first main gamma voltage acquisition unit 43 is configured to use the minimum-grayscale test voltage VGMP₀ at which the actual brightness of the display panel 2 reaches target dark state brightness as a first main gamma voltage VGMP. The analog supply voltage acquisition unit 44 is configured to obtain the analog supply voltage AVDD according to the first main gamma voltage VGMP.

During the acquisition of the analog supply voltage AVDD, the minimum-grayscale test voltage supply unit 41 may first provide the minimum-grayscale test voltage VGMP₀ to the display panel 2. In addition, the brightness acquisition unit 42 acquires in real time the actual brightness of the display panel 2 at the minimum-grayscale test voltage VGMP₀. When the actual brightness of the display panel 2 is less than or equal to the target dark state brightness, the first main gamma voltage acquisition unit 43 may use the minimum-grayscale test voltage VGMP₀ as the first main gamma voltage VGMP. Next, the analog supply voltage acquisition unit 44 may obtain the analog supply voltage AVDD according to the first main gamma voltage VGMP.

According to the module 3 for acquiring the analog supply voltage AVDD provided in this embodiment of the present disclosure, the first main gamma voltage acquisition unit 43 obtains the first main gamma voltage VGMP that matches a structure, a material, or a production process feature of the display panel 2. Driven by the first main gamma voltage VGMP, the actual brightness of the display panel 2 is less than or equal to the target dark state brightness. Next, an analog supply voltage AVDD that meets a requirement of the first main gamma voltage VGMP can be obtained according to the first main gamma voltage VGMP using the analog supply voltage acquisition unit 44, so that the analog supply voltage VGMP is not too large or too small. During the operation of the display apparatus, based on a setting manner provided in this embodiment of the present disclosure, on the one hand, the analog supply voltage AVDD is not too small, thus avoiding a problem that the display panel 2 cannot display with the target dark state brightness and improving a display effect of the display panel 2. On the other hand, the analog supply voltage AVDD is not too large, thus avoiding a problem of excessive power consumption of the display driver chip 1 and reducing the power consumption of the display driver chip 1.

In addition, in this embodiment of the present disclosure, the minimum-grayscale test voltage supply unit 41 provides the minimum-grayscale test voltage VGMP₀ to the display panel 2, the brightness acquisition unit 42 acquires the actual brightness of the display panel 2 at the minimum-grayscale test voltage in real time, the minimum-grayscale test voltage supply unit 41 adjusts, according to the actual brightness of the display panel 2, the minimum-grayscale test voltage VGMP₀ provided by the display driver chip 1, until the actual brightness of the display panel 2 is less than or equal to the target dark state brightness, and at this time. The first main gamma voltage acquisition unit 43 uses the minimum-grayscale test voltage as the first main gamma voltage VGMP. Through this dynamic adjustment process, accuracy of the acquired first main gamma voltage VGMP can be improved, thereby helping further ensure accuracy of the acquired analog supply voltage AVDD.

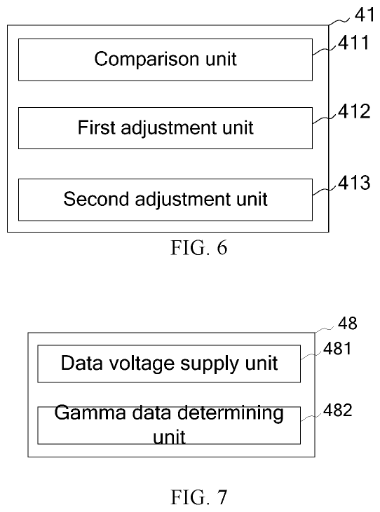

For example, FIG. 6 is a schematic diagram of a minimum-grayscale test voltage supply unit according to an embodiment of the present disclosure. As shown in FIG. 6, in this embodiment of the present disclosure, the minimum-grayscale test voltage supply unit 41 includes a comparison unit 411, a first adjustment unit 412, and a second adjustment unit 413. The comparison unit 411 is configured to compare the actual brightness of the display panel 2 with the target dark state brightness.

The first adjustment unit 412 is configured to increase, when the actual brightness of the display panel 2 is greater than the target dark state brightness, the minimum-grayscale test voltage VGMP₀ provided by the display driver chip 1 with a first preset step ΔV1. In this process, the brightness acquisition unit 42 acquires the actual brightness of the display panel 2 at the current minimum-grayscale test voltage VGMP₀ in real time, and the comparison unit 411 continues comparing the actual brightness of the display panel 2 with the target dark state brightness. When the actual brightness of the display panel 2 is less than or equal to the target dark state brightness, the first adjustment unit 412 stops adjusting, and the first main gamma voltage acquisition unit 43 uses the current minimum-grayscale test voltage VGMP₀ at which the actual brightness of the display panel 2 is less than or equal to the target dark state brightness as the first main gamma voltage VGMP.

The second adjustment unit 413 is configured to decrease, when the actual brightness of the display panel 2 is less than the target dark state brightness, the minimum-grayscale test voltage VGMP₀.provided by the display driver chip 1 with a second preset step ΔV2. In this process, the brightness acquisition unit 42 acquires the actual brightness of the display panel 2 at the current minimum-grayscale test voltage VGMP₀. In addition, the comparison unit 411 continues comparing the actual brightness of the display panel 2 with the target dark state brightness. If the actual brightness of the display panel 2 is still less than the target dark state brightness, the second adjustment unit 413 continues decreasing, with a second preset step ΔV2, the minimum-grayscale test voltage VGMP₀ provided by the display driver chip 1, until the actual brightness of the display panel 2 is greater than or equal to the target dark state brightness. At this time, the second adjustment unit 413 stops adjusting, and the first main gamma voltage acquisition unit 43 uses a smallest one among a plurality of minimum-grayscale test voltages VGMP₀ at which the actual brightness of the display panel 2 is less than or equal to the target dark state brightness as the first main gamma voltage VGMP.

In some embodiments, as shown in FIG. 5, in this embodiment of the present disclosure, the acquisition module 4 further includes a register setting value acquisition unit 45 and a programming unit 46. The register setting value acquisition unit 45 is configured to obtain a register setting value corresponding to the analog supply voltage AVDD according to the analog supply voltage AVDD. The programming unit 46 is configured to program the register setting value into the nonvolatile memory of the display driver chip 1.

For example, as shown in FIG. 5, in this embodiment of the present disclosure, the acquisition module 4 further includes a write unit 47 and a gamma data acquisition unit 48. The write unit 47 is configured to: after the first main gamma voltage VGMP and the register setting value are obtained and before the register setting value is programmed into the nonvolatile memory of the display driver chip 1, write the first main gamma voltage VGMP and the register setting value into the display driver chip 1. The gamma data acquisition unit 48 is configured to: after the first main gamma voltage VGMP and the register setting value are written into the display driver chip 1, perform gamma correction on the display panel 2 to obtain a plurality of gamma data voltages corresponding to different grayscales. The programming unit 46 is further configured to program the gamma data voltage into the display driver chip 1.

For example, FIG. 7 is a schematic diagram of a gamma data acquisition unit according to an embodiment of the present disclosure. As shown in FIG. 7, the gamma data acquisition unit 48 includes a data voltage supply unit 481 and a gamma data determining unit 482. The data voltage supply unit 481 is configured to provide data voltages corresponding to different grayscales to the display panel 2. The brightness acquisition unit 42 is further configured to acquire actual brightness of the display panel 2 at different grayscales. When the actual brightness of the display panel 2 reaches target brightness corresponding to the grayscale, the gamma data determining unit 482 is configured to use the data voltage corresponding to the current grayscale as the gamma data voltage.

An embodiment of the present disclosure further provides a display apparatus. As shown in FIG. 1, the display apparatus includes the display panel 2 and the display driver chip 1. The display driver chip 1 is configured to receive the analog supply voltage AVDD. The magnitude of the analog supply voltage AVDD is determined according to the method described above for each display apparatus before the display apparatus is shipped. The power management chip 3 is set so as to provide analog supply voltage AVDD with the target magnitude to the display driver chip 1. The display driver chip 1 is electrically connected to the display panel 2. For example, the display panel 2 may be an active light-emitting display panel, such as an organic light-emitting diode (OLED) display panel, or may be a liquid crystal display (LCD) panel.

The display apparatus shown in FIG. 1 is for schematic description only. The display apparatus may be any electronic device with a display function, such as a mobile phone, a tablet computer, a notebook computer, an eBook, or a television.

According to the display apparatus provided in this embodiment of the present disclosure, the target first main gamma voltage VGMP matching a structure, a material, or a production process feature of the display panel 2 is first acquired. At the target first main gamma voltage VGMP, the actual brightness of the display panel 2 is closest to the target dark state brightness. Next, an analog supply voltage AVDD that meets a requirement of the first main gamma voltage VGMP can be obtained according to the first main gamma voltage VGMP, so that the analog supply voltage AVDD is not too large or too small. On the one hand, the analog supply voltage AVDD is prevented from being set too small, thus avoiding a problem that the display panel 2 cannot display with the target dark state brightness and improving a display effect of the display panel 2. On the other hand, the analog supply voltage AVDD is prevented from being set too large, thus avoiding a problem of excessive power consumption of the display driver chip 1 and reducing the power consumption of the display driver chip 1.

In addition, in this embodiment of the present disclosure, the minimum-grayscale test voltage VGMP₀ is provided by the display driver chip 1 to the display panel, the actual brightness of the display panel 2 at the minimum-grayscale test voltage is acquired, the minimum-grayscale test voltage VGMP₀ provided by the display driver chip 1 is adjusted according to the actual brightness of the display panel 2, and the minimum-grayscale test voltage at which the actual brightness of the display panel 2 is less than or equal to the target dark state brightness is used as the first main gamma voltage VGMP. Through this dynamic adjustment process, accuracy of the acquired first main gamma voltage VGMP can be improved, thereby helping further ensure accuracy of the acquired analog supply voltage AVDD.

For example, as shown in FIG. 1, the display apparatus further includes the power management chip 3 (such as a power management integrated circuit) electrically connected to the display driver chip 1. The power management chip 3 is configured to provide the analog supply voltage AVDD to the display driver chip 1 based on needs of the display driver chip 1. Optionally, when the display panel includes an OLED display panel, the power management chip 3 is further configured to provide a first supply voltage ELVDD and/or a second supply voltage ELVSS to light-emitting elements in the display panel 1.

For example, the display driver chip 1 includes a register. The register stores a register setting value. The power management chip 3 is configured to provide the analog supply voltage AVDD to the display driver chip 1 according to the register setting value. For example, the display driver chip 1 may send a pulse signal to the power management chip 3. A pulse quantity corresponds to the magnitude of the analog supply voltage AVDD. The power management chip 3 determines the analog supply voltage AVDD according to the pulse quantity.

Embodiments of the present disclosure provide a display apparatus. As shown in FIG. 1, the display apparatus includes a display panel 2, a display driver chip 1, and a power management chip 3.

The power management chip 3 powers the display panel 2 and the display driver chip 1. Specifically, the power management chip 3 supplies a power supply voltage AVDD to the display driver chip 1. The power management chip 3 further supplies a positive supply voltage ELVDD and/or a negative supply voltage ELVSS to the display panel 2.

The display apparatus may further include a central processor. The central processor sends image data to the display driver chip 1. The display driver chip 1 generates grayscale voltages (also referred to as data voltages) according to the image data, and supplies the grayscale voltages to data lines of the display panel 2.

For example, light emission of a pixel or light-emitting element is controlled by the grayscale voltage corresponding to the pixel or light-emitting element. The grayscale voltage may have 256 levels corresponding to 256 grayscale values. When the grayscale voltage corresponding to the grayscale 0 (the minimum grayscale) is supplied to the pixel or light-emitting element, the pixel or light-emitting element is in the black/dark state (minimum luminance). When the grayscale voltage corresponding to the grayscale 255 (the maximum grayscale) is supplied to the pixel or light-emitting element, the pixel or light-emitting element is in the brightest state (maximum luminance). The minimum-grayscale voltage may be referred to as the first main gamma voltage VGMP. The maximum-grayscale voltage may be referred to as the second main gamma voltage VGSP. The grayscale voltages corresponding to grayscales 1-254 are smaller than the first main gamma voltage VGMP and larger than the second main gamma voltage VGSP. Multiple tests are performed before the display apparatus is shipped and after the display apparatus has been assembled. One of the tests is to ensure that the brightness of the display panel driven the minimum-grayscale voltage meets the target dark state brightness.

The display driver chip 1 is powered by the power supply voltage AVDD to generate the grayscale voltages. Accordingly, reducing the magnitude of the power supply voltage AVDD can reduce the power consumption of the display driver chip 1. The display driver chip 1 includes a buck circuit, and the power supply voltage AVDD is greater than or equal to the minimum-grayscale voltage VGMP so as to ensure the display driver chip 1 to generate the minimum-grayscale voltage VGMP. Therefore, a desired magnitude of the power supply voltage AVDD is equal to the magnitude of the minimum-grayscale voltage VGMP, or the difference between the desired magnitude of the power supply voltage AVDD and the magnitude of the minimum-grayscale voltage VGMP is less than a preset value. For example, the difference between the desired magnitude of the power supply voltage AVDD and the magnitude of the minimum-grayscale voltage VGMP is less than 0.4V.

Typically, a large number of display apparatuses are manufactured at the same time, and a same magnitude is arranged for the power supply voltages AVDD provided by the power management chips 3 of the display apparatuses. However, the minimum-grayscale voltages VGMP at which different display panels 2 are at target dark state brightness are different due to material or structure fluctuation of the display panels 2 caused by manufacturing fluctuation. Different display driver chips 1 corresponding to different display panels 2 may need power supply voltages AVDD with different magnitudes. Embodiments of the present disclosure further provide a method for determining a magnitude of the power supply voltage AVDD. The method may be performed before the display apparatus is shipped and after the display apparatus has been assembled.

As shown in FIG. 8, the display driver chip 1 includes a first main gamma voltage generation circuit 11, a second gamma voltage generation circuit 12, a register 13, and a nonvolatile memory 14. The first main gamma voltage generation circuit 11 receives the power supply voltage AVDD from the power management chip 3.

The first main gamma voltage generation circuit 11 generates the minimum-grayscale voltage VGMP. The second gamma voltage generation circuit 12 generates, based on the minimum-grayscale voltage VGMP, grayscale voltages corresponding to other grayscale values. The display driver chip 1 outputs the grayscale voltage to the corresponding data line of the display panel according to the image data.

The magnitude of the minimum-grayscale voltage VGMP is determined by a register setting value acquired from the register 13. The register setting value is a binary number. For example, if the register setting value is increased, the generated minimum-grayscale voltage VGMP has a larger magnitude. For example, the power supply voltage AVDD may be 7.2V, the generated minimum-grayscale voltage VGMP is 6.8V according to a first register setting value, or the generated minimum-grayscale voltage VGMP is 6.4V according to a second register setting value. In the present method, the register setting value may be changed by an operator using a testing tool. In other words, before the display apparatus is shipped, the producer tests the display apparatus using the testing tool.

An initial register setting value is inputted, and the first main gamma voltage generation circuit 11 generates an initial minimum-grayscale test voltage VGMP. The initial minimum-grayscale test voltage VGMP is supplies to the display panel 2, and the display panel 2 is in the dark state.

The actual brightness of the display panel at the initial minimum-grayscale test voltage VGMP is compared with the target dark state brightness.

If the actual brightness of the display panel at the initial minimum-grayscale test voltage VGMP is greater than the target dark state brightness, the magnitude of the generated minimum-grayscale test voltage VGMP is decreased by changing the register preset value in the register 13. Through one or more adjustments, when the actual brightness of the display panel is equal to or less than the target dark state brightness, this minimum-grayscale test voltage VGMP is taken as the target minimum-grayscale voltage VGMP. The register preset value corresponding to this target minimum-grayscale voltage VGMP is programed into the nonvolatile memory 14. The magnitude of the power supply voltage AVDD is determined according to this target minimum-grayscale voltage VGMP. The power management chip 3 is trimmed to supply the power supply voltage AVDD with the determined magnitude. For example, the magnitude of the power supply voltage AVDD is equal to a sum of the magnitude of the target minimum-grayscale voltage VGMP and 0.3V.

If the actual brightness of the display panel at the initial minimum-grayscale test voltage VGMP is less than the target dark state brightness, the magnitude of the generated minimum-grayscale test voltage VGMP is increased by changing the register preset value in the register 13. Through one or more adjustments, when the actual brightness of the display panel is equal to or greater than the target dark state brightness, this minimum-grayscale test voltage VGMP is taken as the target minimum-grayscale voltage VGMP. The register preset value corresponding to this target minimum-grayscale voltage VGMP is programed into the nonvolatile memory 14. The magnitude of the power supply voltage AVDD is determined according to this target minimum-grayscale voltage VGMP. The power management chip 3 is trimmed to supply the power supply voltage AVDD with the determined magnitude. For example, the magnitude of the power supply voltage AVDD is equal to a sum of the magnitude of the target minimum-grayscale voltage VGMP and 0.3V.

The power management chip 3 generates the power supply voltage AVDD. When the display apparatus is received by the customer, the display driver chip 1 sends a signal to the power management chip 3, and the power management chip 3 generates the target power supply voltage AVDD according to the signal. The signal indicates the magnitude of the target power supply voltage AVDD. The signal may be a pulse signal. The number of pulses indicates the magnitude of the target power supply voltage AVDD. The display driver chip 1 generates the signal according to a parameter stored in the nonvolatile memory 14. The parameter is determined by the above method.

In the above method, the target minimum-grayscale voltage VGMP is obtained for each display apparatus. The difference between the target dark state brightness and the dark state brightness of the display panel 2 at the target minimum-grayscale voltage VGMP is less than the preset value. For example, the dark state brightness of the display panel 2 at the target minimum—grayscale voltage VGMP is equal to the target minimum-grayscale voltage VGMP.

With the above method, for different display apparatuses with different target minimum-grayscale voltages VGMP, a display apparatus with a larger target minimum-grayscale voltage VGMP has a larger power supply voltage AVDD, and a display apparatus with a smaller target minimum-grayscale voltage VGMP has a smaller power supply voltage AVDD. It is avoided that a display apparatus with a small target minimum-grayscale voltage VGMP has a large power supply voltage AVDD. The power consumption of each display apparatus is well controlled.

The display apparatus is configured with the above method and then put into market. In the normal operation of the display apparatus, when the display apparatus is powered on, the power management chip 3 generates the power supply voltage AVDD with the target magnitude by reading the parameter in the nonvolatile memory of the power management chip 3. The display driver chip 1 is powered by the power supply voltage AVDD. The register preset value stored in the nonvolatile memory 14 is transferred to the register 13 through a power-on read process, and the display driver chip 1 can generate the target minimum-grayscale voltage VGMP. When the display panel 2 is driven by the target minimum-grayscale voltage VGMP, the display panel 2 is at the target dark state brightness or closest to the target dark state brightness. The target dark state brightness may be 0.001 nit.

The above descriptions are merely preferred embodiments of the present disclosure, and are not intended to limit the present disclosure. Any modifications, equivalent replacements, improvements, and the like made within the spirit and principle of the present disclosure shall fall within the protection scope of the present disclosure.

What is claimed is:

1. A method for acquiring an analog supply voltage, the analog supply voltage being provided to a display driver chip, the display driver chip driving a display panel, and the method comprising:
providing, to the display driver chip, a minimum-grayscale test voltage to the display panel, and acquiring an actual brightness of the display panel at the minimum-grayscale test voltage;
adjusting the minimum-grayscale test voltage according to the actual brightness of the display panel;
using the minimum-grayscale test voltage at which the actual brightness of the display panel reaches target dark state brightness as a first main gamma voltage; and
obtaining the analog supply voltage according to the first main gamma voltage.

2. The method according to claim 1, wherein the step of adjusting the minimum-grayscale test voltage comprises:
comparing the actual brightness of the display panel with the target dark state brightness; and
when the actual brightness of the display panel is greater than the target dark state brightness, increasing the minimum-grayscale test voltage with a first preset step until the actual brightness of the display panel is less than or equal to the target dark state brightness; or
when the actual brightness of the display panel is less than the target dark state brightness, decreasing the minimum-grayscale test voltage with a second preset step until the actual brightness of the display panel is greater than or equal to the target dark state brightness.

3. The method according to claim 1, wherein the step of using the minimum-grayscale test voltage at which the actual brightness of the display panel reaches the target dark state brightness as the first main gamma voltage comprises:
using a smallest one of a plurality of minimum-grayscale test voltages at which the actual brightness of the display panel is less than or equal to the target dark state brightness as the first main gamma voltage.

4. The method according to claim 1, wherein a value V_{GMP} of the first main gamma voltage and a value V_{AVDD} of the analog supply voltage satisfy: V_{AVDD}=V_{GMP}+C, and 0.3 V≤C≤0.5 V.

5. The method according to claim 1, further comprising:
obtaining a register setting value corresponding to the analog supply voltage according to the analog supply voltage; and
storing the register setting value into a nonvolatile memory of the display driver chip.

6. The method according to claim 5, wherein, after obtaining the register setting value and before storing the register setting value into the nonvolatile memory of the display driver chip, the method further comprises:
inputting the register setting value into a register of the display driver chip; and
performing gamma correction on the display panel to obtain gamma data voltages.

7. The method according to claim 5, further comprising storing the gamma data voltages into the display driver chip.

8. The method according to claim 6, wherein the step of performing gamma correction on the display panel to obtain the gamma data voltage comprises:
providing data voltages corresponding to a plurality of grayscales to the display panel; and
acquiring actual brightness of the display panel at each of the plurality of grayscales.

9. The method according to claim 6, wherein, when the actual brightness of the display panel reaches target brightness corresponding to each of the plurality of grayscales, using the data voltage corresponding to each of the plurality of grayscales as the gamma data voltage corresponding to each of the plurality of grayscales.

10. The method according to claim 6, wherein after storing the register setting value into the nonvolatile memory of the display driver chip, the method further comprises:
causing the display panel to emit light based on the register setting value and the first main gamma voltage;
acquiring the actual brightness of the display panel;
reading back the register setting value and the first main gamma voltage in the display driver chip; and
powering off when the actual brightness is less than or equal to the target dark state brightness and when the register setting value and the first main gamma voltage are correct.

11. A display apparatus, comprising a display panel and a display driver chip, wherein the display driver chip is configured to receive an analog supply voltage, wherein the analog supply voltage is obtained according to the method according to claim 1, and the display driver chip is electrically connected to the display panel.

12. The display apparatus according to claim 11, further comprising a power management chip electrically connected to the display driver chip, wherein the power management chip is configured to provide the analog supply voltage to the display driver chip.

13. The display apparatus according to claim 11, wherein the display driver chip comprises a register, the register stores a register setting value, and the power management chip is configured to provide the analog supply voltage to the display driver chip according to the register setting value.

14. A display apparatus, comprising:
a display panel;
a display driver chip; and
a power management chip,
wherein the display driver chip comprises a nonvolatile memory, a first main gamma voltage generation circuit, and a second gamma voltage generation circuit,
wherein the display driver chip sends a signal to the power management chip according to a parameter in the nonvolatile memory, the power management chip generates an analog supply voltage and supplies the analog supply voltage to the display driver chip, and a magnitude of the analog supply voltage is determined by the signal, and
wherein the first main gamma voltage generation circuit generates, based on the analog supply voltage, a gamma voltage corresponding to a grayscale 0.

15. The display apparatus according to claim 14, wherein the signal is a pulse signal, and the magnitude of the analog supply voltage is indicated by a number of pulses of the pulse signal.

16. The display apparatus according to claim 14, wherein the second gamma voltage generation circuit generates, based on the gamma voltage corresponding to the grayscale 0, gamma voltages corresponding to grayscales 1 to 254.

17. The display apparatus according to claim 14, wherein the magnitude of the analog supply voltage is greater than a magnitude of the gamma voltage corresponding to the grayscale 0, and the magnitude of the gamma voltage corresponding to the grayscale 0 is greater than magnitudes of gamma voltages corresponding to grayscales 1 to 254.

18. The display apparatus according to claim 17, wherein the magnitude V_{AVDD} of the analog supply voltage and the magnitude of the gamma voltage corresponding to the grayscale 0 satisfy: V_{AVDD}=V_{GMP}+C, and 0.3 V≤ C≤0.5 V.
